(19) United States
(12) Patent Application Publication
(10) Pub. No.: US 2025/0372725 A1
(43) Pub. Date: Dec. 4, 2025

(54) ZINC SECONDARY BATTERY

(71) Applicant: NGK INSULATORS, LTD., Nagoya-shi (JP)

(72) Inventor: Junki MATSUYA, Chita-County (JP)

(21) Appl. No.: 19/306,184

(22) Filed: Aug. 21, 2025

Related U.S. Application Data
(63) Continuation of application No. PCT/JP2023/040402, filed on Nov. 9, 2023.

(30) Foreign Application Priority Data
Feb. 24, 2023 (JP) 2023-027676

(51) Int. Cl. H01M 10/26; H01M 10/30; H01M 12/02; H01M 12/08; H01M 50/417; H01M 50/434

(52) U.S. Cl. CPC H01M 10/26; H01M 10/30; H01M 12/02; H01M 12/08; H01M 50/417; H01M 50/434; H01M 2300/0014

(57) ABSTRACT

There is provided a zinc secondary battery including a positive electrode plate including a positive electrode active material layer and a positive electrode current collector; a negative electrode plate including a negative electrode active material layer containing at least one selected from the group consisting of zinc, zinc oxide, a zinc alloy, and a zinc compound, and a negative electrode current collector; a hydroxide ion conductive separator that separates the positive electrode plate and the negative electrode plate so as to make hydroxide ions conductable; and an electrolytic solution. The electrolytic solution is an aqueous solution containing an alkali metal hydroxide including at least sodium hydroxide, and a total concentration of the alkali metal hydroxide in the electrolytic solution is from 5.0 to 6.0 mol/L, and a concentration of the sodium hydroxide in the electrolytic solution is from 0.5 to 6.0 mol/L.

### CROSS-REFERENCE TO RELATED APPLICATIONS

This application is a continuation application of PCT/JP2023/040402 filed Nov. 9, 2023, which claims priority to Japanese Patent Application No. 2023-027676 filed Feb. 24, 2023, the entire contents all of which are incorporated herein by reference.

### BACKGROUND OF THE INVENTION

### 1. Field of the Invention

The present disclosure relates to a zinc secondary battery.

### 2. Description of the Related Art

In alkaline batteries, a phenomenon designated as creep (hereinafter referred to as the creep phenomenon) is known. The creep phenomenon is a phenomenon in which alkaline components in the electrolytic solution creep up the surface of an electrode terminal and leak outside a battery container. Therefore, several batteries coping with the creep phenomenon have been proposed. For example, Patent Literature 1 (JPH7-254396A) discloses that in a button-type alkaline battery using mercury-free zinc as a negative electrode active material, by coating the inner surface of a negative electrode terminal plate with tin or a tin alloy to a thickness of 10 to 100 μm to polish the surface, the amount of tin oxide on the surface is controlled to a specified level. Patent Literature 2 (JP6561915B) discloses a nickel hydrogen battery in which an insulating layer is formed on the surface of an electrode terminal, and a metal layer containing nickel and/or a nickel-iron alloy is laminated on this insulating layer.

By the way, it is known that in zinc secondary batteries such as a nickel-zinc secondary battery and an air-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life. In order to cope with this problem, a battery including a layered double hydroxide (LDH) separator that blocks the penetration of zinc dendrite while selectively permeating hydroxide ions has been proposed (see, for example, Patent Literature 3 (WO2016/076047), and Patent Literature 4 (WO2019/124270)). Patent Literature 5 (WO2019/069760) and Patent Literature 6 (WO2019/077953) have proposed a zinc secondary battery having a configuration in which the whole of a negative electrode active material layer is covered or wrapped up with a liquid holding member and an LDH separator, and a positive electrode active material layer is covered or wrapped up with a liquid holding member. As the liquid holding member, a nonwoven fabric is used. It is described that according to such a configuration, complicated sealing and bonding between the LDH separator and a battery container is unnecessary, and hence a zinc secondary battery (especially a stacked-cell battery thereof) capable of preventing zinc dendrite propagation can be produced extremely easily and with high productivity.

Further, LDH-like compounds have being known as hydroxides and/or oxides with a layered crystal structure that cannot be called LDH but are analogous thereto, which exhibit hydroxide ion conductive properties similar to those of a compound to an extent that it can be collectively referred to as hydroxide ion conductive layered compounds together with LDH. For example, Patent Literature 7 (WO2020/255856) discloses a hydroxide ion conductive separator comprising a porous substrate and a layered double hydroxide (LDH)-like compound that clogs up pores in the porous substrate, in which the LDH-like compound is a hydroxide and/or an oxide with a layered crystal structure containing Mg, and one or more elements including at least Ti and selected from the group consisting of Ti, Y and Al. Patent Literature 8 (WO2021/229916) discloses an LDH separator using an LDH-like compound containing (i) Ti, Y, and optionally Al and/or Mg, and (ii) at least one additive element M selected from the group consisting of In, Bi, Ca, Sr and Ba. Further, Patent Literature 9 (WO2021/229917) discloses an LDH separator containing a mixture of an LDH-like compound and In(OH)₃, in which the LDH-like compound is a hydroxide and/or an oxide having a layered crystal structure containing Mg, Ti, Y, and optionally Al and/or In. It is described that the separators disclosed in Patent Literatures 7 to 9 are superior in alkali resistance to conventional LDH separators, and can more effectively suppress a short circuit due to zinc dendrite.

### CITATION LIST

### Patent Literature

Patent Literature 1: JPH7-254396A

Patent Literature 2: JP6561915B

Patent Literature 3: WO2016/076047

Patent Literature 4: WO2019/124270

Patent Literature 5: WO2019/069760

Patent Literature 6: WO2019/077953

Patent Literature 7: WO2020/255856

Patent Literature 8: WO2021/229916

Patent Literature 9: WO2021/229917

### SUMMARY OF THE INVENTION

As disclosed in Patent Literatures 1 and 2, although various attempts have been proposed as a solution to the creep phenomenon in alkaline batteries, there is a demand for a method for more effectively suppressing leakage of an electrolytic solution.

The inventors have now found that, in a zinc secondary battery, the leakage of an electrolytic solution due to the creep phenomenon can be effectively suppressed while exhibiting good battery resistance by setting a total concentration of an alkali metal hydroxide in the electrolytic solution to from 5.0 to 6.0 mol/L, and a concentration of sodium hydroxide to from 0.5 to 6.0 mol/L.

Accordingly, an object of the present invention is to provide a zinc secondary battery capable of effectively suppressing leakage of an electrolytic solution due to the creep phenomenon while exhibiting good battery resistance.

The present invention provides the following aspects:

### Aspect 1

A zinc secondary battery comprising:
a positive electrode plate including a positive electrode active material layer and a positive electrode current collector;
a negative electrode plate including a negative electrode active material layer containing at least one selected from the group consisting of zinc, zinc oxide, a zinc alloy, and a zinc compound, and a negative electrode current collector;
a hydroxide ion conductive separator that separates the positive electrode plate and the negative electrode plate so as to make hydroxide ions conductable; and
an electrolytic solution,
wherein the electrolytic solution is an aqueous solution containing an alkali metal hydroxide including at least sodium hydroxide, and
a total concentration of the alkali metal hydroxide in the electrolytic solution is from 5.0 to 6.0 mol/L, and a concentration of the sodium hydroxide in the electrolytic solution is from 0.5 to 6.0 mol/L.

### Aspect 2

The zinc secondary battery according to aspect 1, wherein the concentration of the sodium hydroxide in the electrolytic solution is from 2.5 to 6.0 mol/L.

### Aspect 3

The zinc secondary battery according to aspect 1 or 2, wherein a ratio of the concentration of the sodium hydroxide to the total concentration of the alkali metal hydroxide is from 0.4 to 1.0.

### Aspect 4

The zinc secondary battery according to any one of aspects 1 to 3, wherein the alkali metal hydroxide consists of the sodium hydroxide.

### Aspect 5

The zinc secondary battery according to any one of aspects 1 to 3, wherein the alkali metal hydroxide further includes potassium hydroxide.

### Aspect 6

The zinc secondary battery according to aspect 5, wherein a concentration of the potassium hydroxide in the electrolytic solution is 3.0 mol/L or less.

### Aspect 7

The zinc secondary battery according to any one of aspects 1 to 3, 5, or 6, wherein the alkali metal hydroxide further includes lithium hydroxide.

### Aspect 8

The zinc secondary battery according to aspect 7, wherein a concentration of the lithium hydroxide in the electrolytic solution is 1.5 mol/L or less.

### Aspect 9

The zinc secondary battery according to any one of aspects 1 to 8, wherein the hydroxide ion conductive separator is an LDH separator containing a layered double hydroxide (LDH) and/or an LDH-like compound.

### Aspect 10

The zinc secondary battery according to aspect 9, wherein the LDH separator further includes a porous substrate, and is composited with the porous substrate with the LDH and/or the LDH-like compound filled in pores in the porous substrate.

### Aspect 11

The zinc secondary battery according to aspect 10, wherein the porous substrate is made of a polymer material.

### Aspect 12

The zinc secondary battery according to any one of aspects 1 to 11, wherein the positive electrode active material layer contains nickel hydroxide and/or nickel oxyhydroxide, whereby the zinc secondary battery is configured as a nickel-zinc secondary battery.

### Aspect 13

The zinc secondary battery according to any one of aspects 1 to 11, wherein the positive electrode active material layer is an air electrode layer, whereby the zinc secondary battery is configured as an air-zinc secondary battery.

### BRIEF DESCRIPTION OF THE DRAWINGS

FIG. 1 is a schematic cross-sectional view illustrating an example of a zinc secondary battery of the present invention.

FIG. 2 is a view schematically illustrating A-A′ cross section of the zinc secondary battery shown in FIG. 1.

FIG. 3 is a perspective view schematically illustrating an electrode laminate of the zinc secondary battery shown in FIG. 1.

FIG. 4 is a schematic cross-sectional view illustrating an electrode laminate of the zinc secondary battery shown in FIG. 1.

FIG. 5 is a schematic cross-sectional view illustrating an example of a mechanism of inhibiting the creep phenomenon in the zinc secondary battery of the present invention.

FIG. 6 is a conceptual view for explaining a mechanism of the creep phenomenon in using a potassium hydroxide aqueous solution as the electrolytic solution.

FIG. 7 is a schematic cross-sectional view illustrating a mechanism by which the electrolytic solution passes through a minute gap between a metal member and a sealing member.

### DETAILED DESCRIPTION OF THE INVENTION

### Zinc Secondary Battery

A zinc secondary battery of the present invention is not especially limited as long as it is a secondary battery using zinc as a negative electrode and using an alkali metal hydroxide aqueous solution having a composition described below as an electrolytic solution. Accordingly, it can be a nickel-zinc secondary battery, a silver oxide-zinc secondary battery, a manganese oxide-zinc secondary battery, an air-zinc secondary battery, or any of other various alkaline zinc secondary batteries. For example, it is preferred that a positive electrode active material layer contains nickel hydroxide and/or nickel oxyhydroxide, whereby the zinc secondary battery is configured as a nickel-zinc secondary battery. Alternatively, a positive electrode active material layer may be an air electrode layer, whereby the zinc secondary battery is configured as an air-zinc secondary battery.

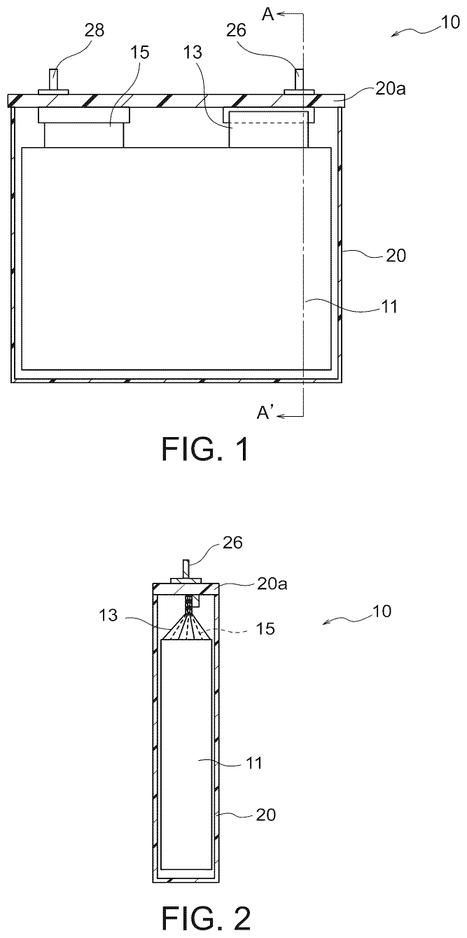

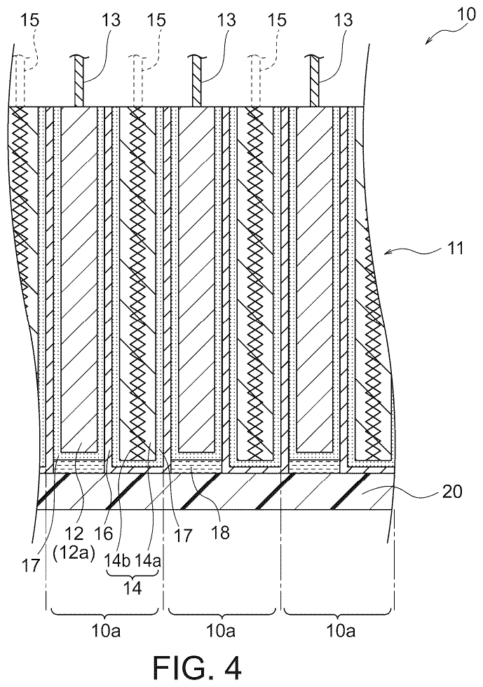

FIGS. 1 to 4 illustrate a zinc secondary battery and an internal structure thereof according to one aspect of the present invention. The zinc secondary battery 10 illustrated in these drawings includes a positive electrode plate 12, a negative electrode plate 14, a hydroxide ion conductive separator 16, and an electrolytic solution 18. Although the electrolytic solution 18 is merely locally illustrated in FIG. 4, this is because the electrolytic solution spreads all over the positive electrode plate 12 and the negative electrode plate 14. The positive electrode plate 12 includes a positive electrode active material layer 12a and a positive electrode current collector (not shown). The negative electrode plate 14 includes a negative electrode active material layer 14a and a negative electrode current collector 14b. The negative electrode active material layer 14a contains at least one selected from the group consisting of zinc, zinc oxide, a zinc alloy, and a zinc compound. The hydroxide ion conductive separator 16 separates the positive electrode plate 12 and the negative electrode plate 14 such that hydroxide ions can be conducted. The electrolytic solution 18 is an aqueous solution containing an alkali metal hydroxide. The alkali metal hydroxide includes at least sodium hydroxide. A total concentration of the alkali metal hydroxide in the electrolytic solution 18 is from 5.0 to 6.0 mol/L. A concentration of sodium hydroxide in the electrolytic solution 18 is from 0.5 to 6.0 mol/L. When the electrolytic solution 18 having the total concentration of the alkali metal hydroxide and the concentration of sodium hydroxide respectively falling in the prescribed ranges is thus used in the zinc secondary battery, the leakage of the electrolytic solution due to the creep phenomenon can be effectively suppressed while exhibiting good battery resistance.

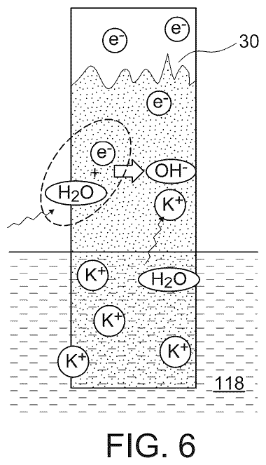

As described above, the creep phenomenon is a phenomenon in which the electrolytic solution creeps up the surface of an electrode terminal and leaks out of the battery container. FIG. 6 conceptually illustrates a mechanism of the creep phenomenon when a portion of a metal member 30 (assumed to be an electrode terminal or current collecting member) is immersed in an electrolytic solution 118 (assumed to be a potassium hydroxide aqueous solution). As illustrated in FIG. 6, the creep phenomenon progresses through steps of 1) H₂O molecules originating from the surrounding environment combine with electrons e-present in the metal member 30 to generate OH⁻, and 2) these OH⁻ attract K⁺ from the electrolytic solution 118. In this manner, components of the electrolytic solution 118 (KOH) are formed in an area of the metal member 30 where the electrolytic solution 118 is not initially present, and as a result, this phenomenon is observed as the phenomenon of the electrolytic solution 118 creeping up the metal member 30. It is noted that the leakage of the electrolytic solution due to the creep phenomenon typically occurs only on the negative electrode side.

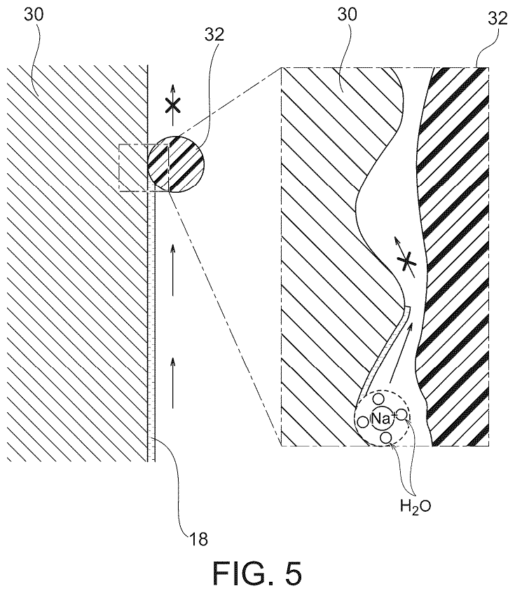

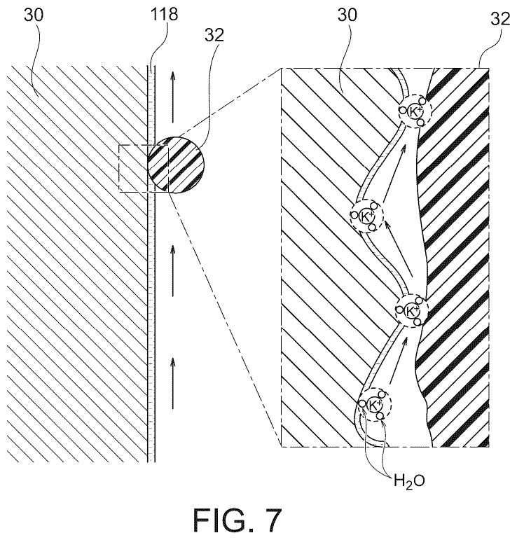

In order to prevent the leakage of the electrolytic solution, a terminal provided inside the container is connected to a terminal provided outside the container via a sealing member such as an O-ring or a gasket. As illustrated in FIG. 7, however, since minute irregularities are present on the surface of the metal member 30 such as an electrode terminal, a minute gap is formed between the metal member 30 and the sealing member 32, and the electrolytic solution 118 unavoidably passes through this minute gap. On the contrary, in the present invention, the leakage of the electrolytic solution due to the creep phenomenon can be effectively suppressed by using the electrolytic solution 18 containing sodium hydroxide in the prescribed concentration as described above. Specifically, an alkali metal hydroxide such as potassium hydroxide or sodium hydroxide exists in the electrolytic solution in a state where cations, such as K⁺ and Na⁺, are hydrated. In this regard, contrary to the ionic radius, the hydrated ionic radius of Na⁺ (approximately 1.8 angstrom) is larger than that of K⁺ (approximately 1.3 angstrom). Therefore, as illustrated in FIG. 5, it is inferred that the electrolytic solution 18 containing sodium hydroxide would be less likely to pass through the minute gap between the metal member 30 and the sealing member 32 compared to a potassium hydroxide aqueous solution commonly used as the electrolytic solution. Besides, the electrolytic solution 18 containing sodium hydroxide in the prescribed concentration has a higher viscosity compared to a potassium hydroxide aqueous solution. As a result, the speed of the electrolytic solution 18 creeping up the metal member 30 is decreased, which can also be considered one of factors capable of suppressing the leakage of the electrolytic solution due to the creep phenomenon.

The electrolytic solution 18 is an aqueous solution containing an alkali metal hydroxide. The total concentration C_{A} of the alkali metal hydroxide in the electrolytic solution 18 is from 5.0 to 6.0 mol/L, preferably from 5.0 to 5.8 mol/L, more preferably from 5.0 to 5.6 mol/L, and particularly preferably from 5.2 to 5.6 mol/L. When the total concentration falls in such a range, the resistance of the electrolytic solution can be preferably reduced, and the performance of the zinc secondary battery can be improved. Examples of the alkali metal hydroxide include, in addition to sodium hydroxide, potassium hydroxide, and lithium hydroxide.

The alkali metal hydroxide contained in the electrolytic solution 18 includes sodium hydroxide. The concentration C_{B} of sodium hydroxide in the electrolytic solution 18 is from 0.5 to 6.0 mol/L, preferably from 2.5 to 6.0 mol/L, more preferably from 3.0 to 6.0 mol/L, further preferably from 4.0 to 6.0 mol/L, still further preferably from 5.0 to 6.0 mol/L, particularly preferably from 5.0 to 5.8 mol/L, and most preferably from 5.2 to 5.6 mol/L. When the concentration falls in such a range, the leakage of the electrolytic solution due to the creep phenomenon can be effectively inhibited. It goes without saying that the concentration C_{B} of sodium hydroxide is not more than the total concentration C_{A} of the alkali metal hydroxide (namely, C_{B}≤C_{A}).

In the electrolytic solution 18, a ratio of the concentration C_{B} of sodium hydroxide to the total concentration C_{A} of the alkali metal hydroxide (=C_{B}/C_{A}) is preferably from 0.4 to 1.0, more preferably from 0.6 to 1.0, further preferably from 0.8 to 1.0, and particularly preferably from 0.9 to 1.0. When the ratio of sodium hydroxide occupying in the alkali metal hydroxide is thus set to be large, the leakage of the electrolytic solution due to the creep phenomenon can be further effectively suppressed.

The alkali metal hydroxide contained in the electrolytic solution 18 may consist of sodium hydroxide. In other words, the total concentration C_{A} of the alkali metal hydroxide and the concentration C_{B} of sodium hydroxide may be the same (C_{A}=C_{B}). Thus, the leakage of the electrolytic solution can be extremely effectively inhibited. Due to raw materials, production process and the like, however, alkali metals except for Na may be mixed as incidental impurities into the electrolytic solution 18. In other words, even when the alkali metal hydroxide includes sodium hydroxide alone, the electrolytic solution 18 may contain an alkali metal hydroxide in addition to sodium hydroxide as an incidental impurity (in a concentration of, for example, less than 0.1 mol/L).

Alternatively, an alkali metal hydroxide except for sodium hydroxide may be intentionally added to the electrolytic solution 18. For example, the electrolytic solution 18 may further contain, as the alkali metal hydroxide, potassium hydroxide and/or lithium hydroxide described above.

When the alkali metal hydroxide contained in the electrolytic solution 18 further includes potassium hydroxide, the battery resistance can be further reduced. On the other hand, from the viewpoint of effectively suppressing the leakage of the electrolytic solution, the amount of potassium hydroxide to be added is preferably limited. From these points of view, when the alkali metal hydroxide further includes potassium hydroxide, a concentration C_{C} of potassium hydroxide in the electrolytic solution 18 is preferably 4.0 mol/L or less, more preferably 3.0 mol/L or less, further preferably 2.0 mol/L or less, particularly preferably 1.5 mol/L or less, and most preferably 1.0 mol/L or less. Besides, a ratio of the concentration C_{C} of potassium hydroxide to the total concentration C_{A} of the alkali metal hydroxide (=C_{C}/C_{A}) is preferably 0.8 or less, more preferably 0.6 or less, further preferably 0.4 or less, and particularly preferably 0.3 or less.

When the alkali metal hydroxide contained in the electrolytic solution 18 further includes lithium hydroxide, the leakage of the electrolytic solution can be further definitely suppressed. Specifically, the hydrated ionic radius of Li⁺ (approximately 2.4 angstrom) is larger than those of K⁺ and Na⁺. Besides, a lithium hydroxide aqueous solution has a higher viscosity than a sodium hydroxide aqueous solution of the same concentration. Accordingly, the creep phenomenon can be more effectively inhibited by adding lithium hydroxide to the electrolytic solution 18. On the other hand, from the viewpoint of effectively reducing the battery resistance, the amount of lithium hydroxide to be added is preferably limited. From these points of view, when the alkali metal hydroxide further includes lithium hydroxide, a concentration C_{D} of lithium hydroxide in the electrolytic solution 18 is preferably 1.5 mol/L or less, more preferably 1.0 mol/L or less, further preferably from 0.1 to 0.8 mol/L, and particularly preferably from 0.2 to 0.5 mol/L. Besides, a ratio of the concentration C_{D} of lithium hydroxide to the total concentration C_{A} of the alkali metal hydroxide (=C_{D}/C_{A}) is preferably 0.3 or less, more preferably from 0 to 0.2, further preferably from 0 to 0.15, and particularly preferably from 0 to 0.1. When lithium hydroxide is added to the electrolytic solution 18, it is preferable to add also potassium hydroxide to the electrolytic solution 18 from the viewpoint of achieving a good balance between the reduction of the battery resistance and the suppression of the leakage of the electrolytic solution. In other words, when the alkali metal hydroxide includes sodium hydroxide and lithium hydroxide, it is preferable to further include potassium hydroxide.

In order to inhibit self-dissolution of zinc and/or zinc oxide, a zinc compound such as zinc oxide, or zinc hydroxide may be added to the electrolytic solution. In order to further effectively prevent the leakage of the electrolytic solution, the electrolytic solution 18 may be gelled. As a gelling agent, a polymer that absorbs a solvent of the electrolytic solution to swell is preferably used, and a polymer such as polyethylene oxide, polyvinyl alcohol, or polyacrylamide, or starch is used.

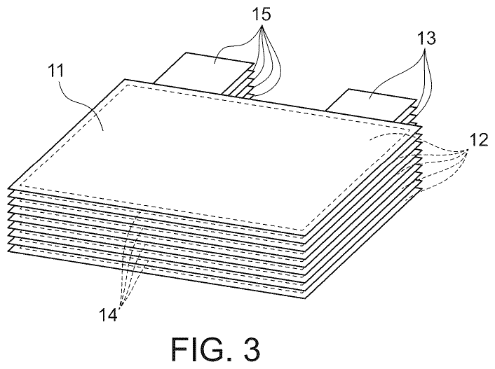

The zinc secondary battery 10 preferably includes electrode laminates 11 and the electrolytic solution 18 housed in a battery container 20. The electrode laminates 11 are formed, as illustrated in FIGS. 3 and 4, into a positive/negative electrode laminate including a plurality of positive electrode plates 12, a plurality of negative electrode plates 14, and a plurality of hydroxide ion conductive separators 16 in which a unit of the positive electrode plate 12/the separator 16/the negative electrode plate 14 is repeatedly stacked. In other words, the zinc secondary battery 10 includes a plurality of unit cells 10a each including the positive electrode plate 12, the positive electrode current collecting member 13, the negative electrode plate 14, the negative electrode current collecting member 15, the hydroxide ion conductive separator 16, and the electrolytic solution 18, and thus, the plurality of unit cells 10a preferably form a multilayer cell as a whole. This is a configuration of what is called a battery pack or stacked cell battery, and this configuration is advantageous in obtaining a high voltage and a large current.

The positive electrode plate 12 includes the positive electrode active material layer 12a. A positive electrode active material contained in the positive electrode active material layer 12a is not especially limited, and may be appropriately selected from known positive electrode materials in accordance with the type of zinc secondary battery. For example, in a nickel-zinc secondary battery, a positive electrode containing nickel hydroxide and/or nickel oxyhydroxide may be used. Alternatively, in an air-zinc secondary battery, an air electrode may be used as the positive electrode. The positive electrode plate 12 further includes a positive electrode current collector (not shown), and it is preferable to further provide the metallic positive electrode current collecting member 13 that extends from or is connected (for example, upward) to the positive electrode current collector. A preferred example of the positive electrode current collector includes a nickel porous substrate such as a foam nickel plate. In this case, for example, when a paste containing an electrode active material such as nickel hydroxide is uniformly applied on a nickel porous substrate, and the resultant is dried, a positive electrode plate including a positive electrode/positive electrode current collector can be favorably produced. At this point, it is also preferred that the dried positive electrode plate (namely, the positive electrode/positive electrode current collector) is subjected to pressing to prevent the electrode active material from coming off and to improve electrode density. Although the positive electrode plate 12 illustrated in FIG. 4 includes a positive electrode current collector (of, for example, foam nickel), it is not illustrated therein. This is because the positive electrode current collector and the positive electrode active material are completely mixed in a nickel-zinc secondary battery, and hence the positive electrode current collector cannot be individually illustrated. The positive electrode current collecting member 13 may be made of the same material as the positive electrode current collector, or may be made of a different material. When the positive electrode current collector is a porous nickel substrate, such as a foam nickel plate, it can be formed into a tab-like shape by pressing. In any case, the positive electrode current collecting member 13 may be extended by attaching another current collecting member such as a tab lead to such a tab. In any case, it is preferable that a plurality of positive electrode current collecting members 13 are joined to one positive electrode terminal 26 or to another positive electrode current collecting member 13 that is electrically connected thereto. The positive electrode terminal 26 is typically connected to the positive electrode current collecting member 13, and protrudes from the battery container 20.

The positive electrode plate 12 may contain an additive that is at least one selected from the group consisting of a silver compound, a manganese compound, and a titanium compound, and thus, a positive electrode reaction for absorbing hydrogen gas generated through self-discharge reaction can be accelerated. Besides, the positive electrode plate 12 may further contain cobalt. Cobalt is contained in the positive electrode plate 12 preferably in the form of cobalt oxyhydride. In the positive electrode plate 12, cobalt functions as a conductive auxiliary agent to contribute to improvement of charge/discharge capacity.

The negative electrode plate 14 includes the negative electrode active material layer 14a. A negative electrode active material contained in the negative electrode active material layer 14a contains at least one selected from the group consisting of zinc, zinc oxide, a zinc alloy, and a zinc compound. The zinc may be contained in any form of a zinc metal, a zinc compound, and a zinc alloy as long as it has electrochemical activity suitable for the negative electrode. Preferred examples of the negative electrode material include zinc oxide, a zinc metal, and calcium zincate, and a mixture of a zinc metal and zinc oxide is more preferred. The negative electrode active material may be in the form of a gel, or may be mixed with the electrolytic solution 18 to obtain a negative electrode mixture. For example, a gelled negative electrode can be easily obtained by adding an electrolytic solution and a thickener to a negative electrode active material. Examples of the thickener include polyvinyl alcohol, polyacrylate, CMC, and alginic acid, and polyacrylic acid is preferred because of excellent chemical resistance to strong alkali.

As the zinc alloy, a zinc alloy containing neither mercury nor lead, known as mercury-free zinc alloy, can be used. For example, a zinc alloy containing 0.01 to 0.1% by mass of indium, 0.005 to 0.02% by mass of bismuth, and 0.0035 to 0.015% by mass of aluminum is preferred because it has an effect of inhibiting hydrogen gas generation. In particular, indium and bismuth are advantageous in improving discharge performance. When a zinc alloy is used in the negative electrode, a self-dissolution rate in an alkaline electrolytic solution is decreased to inhibit hydrogen gas generation, and thus, safety can be improved.

The shape of the negative electrode material is not especially limited, and is preferably a powder shape, and thus, the surface area is increased to cope with large current discharge. A preferred average particle size of the negative electrode material is, in using a zinc alloy, in a range of 3 to 100 μm in minor axis, and when the average particle size is within this range, the surface area is so large that large current discharge can be suitably coped with, and in addition, the material can be easily homogeneously mixed with an electrolytic solution and a gelling agent, and handleability in assembling the battery is favorable.

The negative electrode plate 14 further includes the negative electrode current collector 14b. The negative electrode current collector 14b is provided inside and/or on the surface of the negative electrode active material layer 14a excluding a portion thereof extending as the negative electrode current collecting member 15. In other words, the negative electrode active material layer 14a may be arranged on both surfaces of the negative electrode current collector 14b, or the negative electrode active material layer 14a may be arranged on merely one surface of the negative electrode current collector 14b. In addition, it is preferable that the metallic negative electrode current collecting member 15 is further provided to extend from or to be connected (for example, upward) to the negative electrode current collector 14b. The negative electrode current collecting member 15 is preferably provided at a position that does not overlap with the positive electrode current collecting member 13. The negative electrode current collecting member 15 may be made of the same material as the negative electrode current collector 14b, or may be made of a different material. In any case, the negative electrode current collecting member 15 may be extended by attaching another current collecting member such as a tab lead to such a tab. In any case, it is preferable that a plurality of negative electrode current collecting members 15 are joined to one negative electrode terminal 28 or to another negative electrode current collecting member 15 that is electrically connected thereto. The negative electrode terminal 28 is typically connected to the negative electrode current collecting member 15, and protrudes from the battery container 20.

For the negative electrode current collector 14b, it is preferable to use a metal plate having a plurality of (or a large number of) openings from the viewpoint of adhesion of the active material. Preferred examples of such a negative electrode current collector 14b include an expanded metal, a punched metal, a metal mesh, and a combination thereof, more preferred examples include a copper expanded metal, a copper punched metal, and a combination thereof, and a particularly preferred example includes a copper expanded metal. In this case, for example, a negative electrode plate including a negative electrode/negative electrode collector can be favorably produced by applying, on a copper expanded metal, a mixture containing a zinc oxide powder and/or a zinc powder, and optionally a binder (for example, a polytetrafluoroethylene particle). At this point, it is also preferred that the dried negative electrode plate (namely, the negative electrode/negative electrode current collector) is subjected to pressing to prevent the electrode active material from coming off and to improve electrode density. An expanded metal refers to a mesh-shaped metal plate obtained by forming and expanding staggered cuts in a metal plate with an expanded metal machine, and shaping the cuts into a diamond shape or a hexagonal shape. A punched metal is also designated as a perforated metal, and refers to a metal plate provided with holes by punching. A metal mesh is a metal product having a wire mesh structure, and is different from an expanded metal and a punched metal.

The hydroxide ion conductive separator 16 is provided to separate the positive electrode plate 12 and the negative electrode plate 14 such that hydroxide ions can be conducted. For example, as illustrated in FIGS. 4, the negative electrode plate 14 may be configured to be covered or wrapped up with the hydroxide ion conductive separator 16. In such a manner, complicated sealing and bonding between the hydroxide ion conductive separator 16 and a battery container is unnecessary, and hence a zinc secondary battery (especially a stacked-cell battery thereof) capable of preventing zinc dendrite propagation can be produced extremely easily and with high productivity. A simple configuration in which the hydroxide ion conductive separator 16 is arranged on one side of the positive electrode plate 12 or the negative electrode plate 14 may be employed.

The hydroxide ion conductive separator 16 is not especially limited as long as it is a separator capable of separating the positive electrode plate 12 and the negative electrode plate 14 such that hydroxide ions can be conducted, and representatively is a separator that contains a hydroxide ion conductive solid electrolyte, and selectively passes hydroxide ions by solely utilizing hydroxide ion conductivity. A preferred hydroxide ion conductive solid electrolyte is a layered double hydroxide (LDH) and/or an LDH-like compound. Accordingly, the hydroxide ion conductive separator 16 is preferably an LDH separator. The “LDH separator” herein is a separator containing an LDH and/or an LDH-like compound, and is defined as a separator that selectively passes hydroxide ions by solely utilizing hydroxide ion conductivity of the LDH and/or the LDH-like compound. The “LDH-like compound” herein is a hydroxide and/or an oxide having a layered crystal structure with hydroxide ion conductivity but is a compound that may not be called LDH, and it can be said to be an equivalent of LDH. However, according to a broad sense of definition, it can be appreciated that “LDH” encompasses not only LDH but also LDH-like compounds. The LDH separator is preferably composited with a porous substrate. Accordingly, it is preferred that the LDH separator further includes a porous substrate, and is composited with the porous substrate with the LDH and/or the LDH-like compound filled in pores in the porous substrate. In other words, in a preferred LDH separator, the LDH and/or the LDH-like compound clogs up pores in the porous substrate so that hydroxide ion conductivity and gas impermeability can be exhibited (thereby the LDH separator can function as an LDH separator exhibiting hydroxide ion conductivity). The porous substrate is preferably made of a polymer material, and the LDH and/or LDH-like compound is particularly preferably incorporated over the entire area in the thickness direction of the porous substrate made of a polymer material. For example, known LDH separators disclosed in Patent Literatures 3 to 9 can be used. The thickness of the LDH separator is preferably 5 to 100 μm, more preferably 5 to 80 μm, further preferably 5 to 60 μm, and particularly preferably 5 to 40 μm.

As illustrated in FIGS. 1, 2, and 4, the positive electrode plate 12, the positive electrode current collecting member 13, the negative electrode plate 14, the negative electrode current collecting member 15, and the hydroxide ion conductive separator 16 are vertically arranged, and the positive electrode terminal 26 and the negative electrode terminal 28 are preferably provided on a top cover 20a of the battery container 20. Accordingly, in the case of a multilayer cell, it is preferable that the cells are multilayered in the lateral direction. Besides, the positive electrode current collecting member 13 and the negative electrode current collecting member 15 preferably extend upward.

The zinc secondary battery 10 may further include a liquid holding member 17 that contacts the positive electrode plate 12 and/or the negative electrode plate 14. For example, it is preferred that not only the hydroxide ion conductive separator 16 but also the liquid holding member 17 is interposed between the positive electrode plate 12 and the negative electrode plate 14. Then, as illustrated in FIGS. 4, the positive electrode plate 12 and/or the negative electrode plate 14 is preferably covered or wrapped up with the liquid holding member 17. A simple configuration in which the liquid holding member 17 is arranged on one side of the positive electrode plate 12 or the negative electrode plate 14 may be employed. In either configuration, since the liquid holding member 17 is thus interposed, the electrolytic solution 18 can be uniformly present between the positive electrode plate 12 and/or the negative electrode plate 14, and the hydroxide ion conductive separator 16, and thus, hydroxide ions can be efficiently transferred between the positive electrode plate 12 and/or the negative electrode plate 14, and the hydroxide ion conductive separator 16. The liquid holding member 17 is not especially limited as long as it is a member capable of holding the electrolytic solution 18, and is preferably a sheet-shaped member. Preferable examples of the liquid holding member 17 include a nonwoven fabric, a water-absorbent resin, a liquid retaining resin, a porous sheet, and various spacers, and a nonwoven fabric is particularly preferred because a good performance negative electrode structure can be produced at low cost. The liquid holding member 17 or the nonwoven fabric has a thickness of preferably 10 to 200 μm, more preferably 20 to 200 μm, further preferably 20 to 150 μm, particularly preferably 20 to 100 μm, and most preferably 20 to 60 μm. When the thickness falls in this range, with the entire size of the positive electrode structure and/or the negative electrode structure efficiently suppressed to be compact, a sufficient amount of the electrolytic solution 18 can be held in the liquid holding member 17.

When the positive electrode plate 12 and/or the negative electrode plate 14 are covered or wrapped up with the liquid holding member 17 and/or the hydroxide ion conductive separator 16, outer edges thereof (excluding a side on which the positive electrode current collecting member 13 or the negative electrode current collecting member 15 is extended) are preferably closed. In this case, closed sides of the outer edges of the liquid holding member 17 and/or the hydroxide ion conductive separator 16 are preferably realized by bending the liquid holding member 17 and/or the hydroxide ion conductive separator 16, or sealing the edges of the liquid holding member 17 and/or the edges of the hydroxide ion conductive separator 16. Preferred examples of the sealing method include an adhesive, thermal welding, ultrasonic welding, an adhesive tape, a sealing tape, and a combination thereof. In particular, an LDH separator including a porous substrate made of a polymer material has flexibility, and hence is advantageously easily bent, and therefore, it is preferred that the LDH separator formed into a rectangular shape is bent to obtain a state where one side of the outer edges is closed. For thermal welding and ultrasonic welding, a commercially available heat sealer or the like may be used, and in sealing the edges of an LDH separator, it is preferred to perform the thermal welding and the ultrasonic welding with an outer circumferential portion of the liquid holding member 17 sandwiched between outer circumferential portions of the LDH separator because the sealing can be thus more effectively performed. On the other hand, as an adhesive, an adhesive tape, and a sealing tape, commercially available products may be used, and in order to prevent deterioration otherwise caused in an alkaline electrolytic solution, one containing an alkali resistant resin is preferred. From this point of view, preferred examples of the adhesive include an epoxy resin-based adhesive, a natural resin-based adhesive, a modified olefin resin-based adhesive, and a modified silicone resin-based adhesive, among which an epoxy resin-based adhesive is more preferred because of excellent alkali resistance. An example of products of the epoxy resin-based adhesive includes an epoxy adhesive, Hysol® (manufactured by Henkel).

The outer edge on one side corresponding to the upper edge of the hydroxide ion conductive separator 16 is preferably opened. Such a top open type configuration makes it possible to deal with a problem occurring upon overcharge in a nickel-zinc battery and the like. Specifically, when a nickel-zinc battery or the like is overcharged, oxygen (O₂) can be generated in the positive electrode plate 12, but the LDH separator has such a high density as to substantially pass only hydroxide ions, and hence does not pass O₂. In this regard, when the above-described top open type configuration is employed, O₂ can be transferred above the positive electrode plate 12 to be sent toward the negative electrode plate 14 through the top open portion in the battery container 20, and thus, Zn of a negative electrode active material can be oxidized with the O₂ to be restored to ZnO. Owing to such an oxygen reaction cycle, overcharge resistance can be improved by using top open type electrode laminates 11 in a sealed zinc secondary battery. Even when the outer edge on one side corresponding to the upper edge of the hydroxide ion conductive separator 16 or the liquid holding member 17 is closed, the same effect as that obtained by the open type configuration can be expected by providing a vent hole in a part of the closed outer edge. For example, a vent hole may be formed after sealing the outer edge on one side corresponding to the upper edge of the LDH separator, or a part of the outer edge may be left unsealed in sealing so as to form a vent hole therein.

The battery container 20 is preferably made of a resin. The resin constituting the battery container 20 is preferably a resin having resistance to an alkali metal hydroxide such as potassium hydroxide, more preferably a polyolefin resin, an ABS resin, or modified polyphenylene ether, and further preferably an ABS resin or modified polyphenylene ether. The battery container 20 has a top cover 20a. The battery container 20 (for example, the top cover 20a) may have a pressure release valve for releasing a gas. Besides, a container group in which two or more battery containers 20 are arranged may be housed in an outer frame to obtain a configuration of a battery module.

### EXAMPLES

The present invention will be more specifically described with reference to the following examples.

### Examples 1 to 9

### (1) Production of Nickel-Zinc Secondary Battery

The following positive electrode plate, positive electrode current collecting member, negative electrode plate, negative electrode current collecting member, LDH separator, nonwoven fabric, battery container, and electrolytic solution were prepared. Here, various electrolytic solutions were prepared by changing the types and concentrations of alkali metal hydroxides.
Positive electrode plate: one obtained by filling pores of foam nickel with a positive electrode paste containing nickel hydroxide and a binder, and drying the resultant (an uncoated area, where the positive electrode paste was not applied, remaining near one edge of the foam nickel)
Positive electrode current collecting member: one obtained by compressing, into a tab, the uncoated area of the foam nickel constituting the positive electrode plate by roll pressing, and extending the tab by ultrasonic welding a tab lead (made of pure nickel, thickness: 100 μm) thereto
Negative electrode plate: one obtained by pressure-bonding, to a current collector (copper expanded metal), a negative electrode paste containing a ZnO powder, a metal Zn powder, polytetrafluoroethylene (PTFE), and propylene glycol (an uncoated area, where the negative electrode paste was not applied, remaining near one edge of the copper expanded metal)
Negative electrode current collecting member: one obtained by connecting a tab lead (made of copper, thickness: 100 μm) to the uncoated area of the copper expanded metal by ultrasonic welding
LDH separator: one obtained by precipitating Ni—Al—Ti—LDH (layered double hydroxide) in pores and on the surface of a polyethylene microporous film by hydrothermal synthesis, and roll-pressing the resultant, thickness: 20 μm
Nonwoven fabric: made of polypropylene, thickness: 100 μm
Battery container: box-shaped case made of modified polyphenylene ether resin (equipped with a pressure relief valve capable of releasing gas generated therein), inner dimensions: 190 mm in length, 24 mm in width, 165 mm in height, outer dimensions: 200 mm in length, 30 mm in width, 170 mm in height (excluding the height of the positive electrode terminal and the negative electrode terminal)
Electrolytic solutions: alkali metal hydroxide aqueous solutions having compositions shown in Table 1 containing 0.4 mol/L ZnO dissolved therein

The positive electrode plate was wrapped up with the non-woven fabric so as to cover both sides, with the non-woven fabric slightly protruding from the three sides excluding one side on which the positive electrode current collecting member extended. The excess portions of the non-woven fabric protruding from the three sides of the positive electrode plate were thermally welded using a heat seal bar to obtain a positive electrode structure. Besides, the negative electrode plate was wrapped up successively with the non-woven fabric and the LDH separator so as to cover both sides, with the non-woven fabric and the LDH separator slightly protruding from the three sides excluding one side on which the negative electrode current collecting member extended. The excess portions of the non-woven fabric and the LDH separator protruding from the three sides of the negative electrode plate were thermally welded using a heat seal bar to obtain a negative electrode structure. In this manner, a plurality of positive electrode structures and a plurality of negative electrode structures were prepared.

The 12 positive electrode structures and the 13 negative electrode structures were alternately stacked to produce an electrode laminate. In the same manner as in the configuration illustrated in FIG. 3, the plurality of positive electrode current collecting members 13 and the plurality of negative electrode current collecting members 15 were designed to extend from the electrode current collector at different positions when seen in a plan view, and therefore, the plurality of positive electrode current collecting members 13 were stacked, and the plurality of negative electrode current collecting members 15 were stacked at a different position. As illustrated in FIGS. 1 and 2, the portions of the plurality of positive electrode current collecting members 13 stacked on one another were collectively joined to the positive electrode terminal 26 by laser welding. Similarly, the portions of the plurality of negative electrode current collecting members 15 stacked on one another were collectively joined to the negative electrode terminal 28 by laser welding. In this manner, a stack of the electrode structures including the positive electrode current collecting members 13 and the negative electrode current collecting members 15 was obtained as an electrode laminate 11. This electrode laminate 11 was housed in the box-shaped battery container 20, the electrolytic solution 18 was injected thereinto to impregnate the electrode laminate 11, and the top cover 20a was closed and sealed. Thus, a nickel zinc secondary battery was produced.

### (2) Evaluation of Battery Resistance

A charge/discharge device (TOSCAT3100, manufactured by Toyo System Co., Ltd.) was used for subjecting the thus produced nickel zinc secondary battery to chemical conversion by charge at 0.1 C and discharge at 0.2 C. Thereafter, a 0.5 C charge-discharge cycle was performed once, and a Coulombic efficiency value was calculated by dividing the discharge capacity by the charge capacity and multiplying the result by 100 (=(discharge capacity/charge capacity)×100). The obtained Coulombic efficiency value was evaluated based on the following criteria. The results are shown in Table 1. Regarding a sample with battery resistance evaluated as rating C, it is inferred that the discharge reaction was not completed because of high resistance of the electrolytic solution, and hence the Coulombic efficiency was deteriorated.

### Battery Resistance Evaluation Criteria

Rating A: The Coulombic efficiency value is 99% or more.
Rating B: The Coulombic efficiency value is more than 95% and less than 99%.
Rating C: The Coulombic efficiency value is 95% or less (failure).

### (3) Evaluation of Leakage Resistance

The produced nickel zinc secondary battery was stored in a high temperature, high humidity environment (65° C./80%). The number of days from the start of the storage until electrolytic solution-derived carbonate deposited on the upper part of the negative electrode terminal 28 was first visually observed was counted. The number of days until the salt deposition was evaluated based on the following criteria. The results are shown in Table 1.

### Leakage Resistance Evaluation Criteria

Rating A: The number of days until the salt deposition is 50 days or more.
Rating B: The number of days until the salt deposition is from 11 to 49 days.
Rating C: The number of days until the salt deposition is 10 days or less (failure).

TABLE 1
Table 1

| | Electrolytic Solution | | | | | |
|---|---|---|---|---|---|---|
| | Concentrations of Alkali | | | | | |
| | Hydroxides (mol/L) | | | | Evaluation | |
| | | | | Total | Battery | Leakage |
| | KOH | NaOH | LiOH | Concentration | Resistance | Resistance |
| Ex. 1 | 2.5 | 2.5 | 0 | 5.0 | B | B |
| Ex. 2 | 1.0 | 4.0 | 0 | 5.0 | B | A |
| Ex. 3 | 0 | 6.0 | 0 | 6.0 | B | A |
| Ex. 4 | 4.0 | 0.5 | 0.5 | 5.0 | B | A |
| Ex. 5* | 5.0 | 0 | 0 | 5.0 | A | C |
| Ex. 6* | 6.0 | 0 | 0 | 6.0 | A | C |
| Ex. 7* | 0 | 4.0 | 0 | 4.0 | C | A |
| Ex. 8* | 0 | 7.0 | 0 | 7.0 | C | A |
| Ex. 9* | 3.5 | 0 | 1.5 | 5.0 | C | A |

*corresponds to Comparative Example.

What is claimed is:

1. A zinc secondary battery comprising:
a positive electrode plate including a positive electrode active material layer and a positive electrode current collector;
a negative electrode plate including a negative electrode active material layer containing at least one selected from the group consisting of zinc, zinc oxide, a zinc alloy, and a zinc compound, and a negative electrode current collector;
a hydroxide ion conductive separator that separates the positive electrode plate and the negative electrode plate so as to make hydroxide ions conductable; and
an electrolytic solution,
wherein the electrolytic solution is an aqueous solution containing an alkali metal hydroxide including at least sodium hydroxide, and
a total concentration of the alkali metal hydroxide in the electrolytic solution is from 5.0 to 6.0 mol/L, and a concentration of the sodium hydroxide in the electrolytic solution is from 0.5 to 6.0 mol/L.

2. The zinc secondary battery according to claim 1, wherein the concentration of the sodium hydroxide in the electrolytic solution is from 2.5 to 6.0 mol/L.

3. The zinc secondary battery according to claim 1, wherein a ratio of the concentration of the sodium hydroxide to the total concentration of the alkali metal hydroxide is from 0.4 to 1.0.

4. The zinc secondary battery according to claim 1, wherein the alkali metal hydroxide consists of the sodium hydroxide.

5. The zinc secondary battery according to claim 1, wherein the alkali metal hydroxide further includes potassium hydroxide.

6. The zinc secondary battery according to claim 5, wherein a concentration of the potassium hydroxide in the electrolytic solution is 3.0 mol/L or less.

7. The zinc secondary battery according to claim 5, wherein the alkali metal hydroxide further includes lithium hydroxide.

8. The zinc secondary battery according to claim 7, wherein a concentration of the lithium hydroxide in the electrolytic solution is 1.5 mol/L or less.

9. The zinc secondary battery according to claim 1, wherein the hydroxide ion conductive separator is an LDH separator containing a layered double hydroxide (LDH) and/or an LDH-like compound.

10. The zinc secondary battery according to claim 9, wherein the LDH separator further includes a porous substrate, and is composited with the porous substrate with the LDH and/or the LDH-like compound filled in pores in the porous substrate.

11. The zinc secondary battery according to claim 10, wherein the porous substrate is made of a polymer material.

12. The zinc secondary battery according to claim 1, wherein the positive electrode active material layer contains nickel hydroxide and/or nickel oxyhydroxide, whereby the zinc secondary battery is configured as a nickel-zinc secondary battery.

13. The zinc secondary battery according to claim 1, wherein the positive electrode active material layer is an air electrode layer, whereby the zinc secondary battery is configured as an air-zinc secondary battery.
